(19) United States
(12) Patent Application Publication
(10) Pub. No.: US 2015/0023053 A1
(43) Pub. Date: Jan. 22, 2015

(54) BACKLIGHT UNIT INCLUDING COLOR-COMPENSATING DIFFUSER AND DISPLAY DEVICE INCLUDING THE SAME

(71) Applicant: SAMSUNG DISPLAY CO., LTD., Yongin-City (KR)

(72) Inventors: HYUN-JEONG KIM, Hwaseong-Si (KR); EUI JEONG KANG, Suwon-Si (KR); HYUK-HWAN KIM, Hwaseong-Si (KR); SEOK HYUN NAM, Seoul (KR); KANG-WOO LEE, Seoul (KR)

(21) Appl. No.: 14/335,575

(22) Filed: Jul. 18, 2014

(30) Foreign Application Priority Data
Jul. 22, 2013 (KR) 10-2013-0086117

(51) Int. Cl. F21V 8/00

(52) U.S. Cl. CPC G02B 6/0061; G02B 6/0051; G02B 6/002
USPC 362/607

(57) ABSTRACT

A backlight unit includes a light source. A light guide plate receives light supplied from the light source at an incident light part of the light guide plate. A reflective sheet is positioned below the light guide plate and reflects light upwardly. A diffuser sheet is formed on the light guide plate and diffuses the light to transfer the diffused light upwardly. The diffuser sheet includes a color material, and a concentration of the color material within the diffuser sheet is dependent upon a distance from the incident light part.

### CROSS-REFERENCE TO RELATED APPLICATION

This application claims priority to and the benefit of Korean Patent Application No. 10-2013-0086117 filed in the Korean Intellectual Property Office on Jul. 22, 2013, the entire contents of which are herein incorporated by reference.

### TECHNICAL FIELD

The present invention relates to a display device, and more particularly, to a backlight unit including a color-compensating diffuser and a display device including the same.

### DISCUSSION OF THE RELATED ART

A liquid crystal display (LCD) is an example of a flat panel display that is noted for its small size, light weight, and low power consumption as compared to cathode ray tube (CRT) displays. Currently, LCDs have been installed and used as display devices in a wide variety of information processing devices.

Generally, to construct a liquid crystal display device, a liquid crystal material is injected between an upper substrate where a common electrode, a color filer, and the like are formed and a lower substrate where a thin film transistor, a pixel electrode, and the like are formed. An electric field is formed within the LCD device by applying different electrical potentials to the pixel electrode and the common electrode to change alignment of liquid crystal molecules, thereby controlling transmittance of light to express an image.

In the liquid crystal display, since a liquid crystal panel is a light receiving element which does not self-emit light, a backlight unit for providing light to the liquid crystal panel from the lower side of the liquid crystal panel is included. The backlight unit includes a light source, a light guide plate, a reflective sheet, optical sheets, and the like.

In the backlight unit, the light source uses either a fluorescent light source such as a cold-cathode fluorescent lamp (CCFL) or one or more light sources including a light emitting diode (LED). The light emitting diode occupies a small area as compared with the fluorescent light source and accordingly, LED backlights are well suited for manufacturing slim display devices.

As LEDs may be monochromatic, white light may be created using LEDs by either using a phosphor in combination with a blue light source or by combining various light sources and the phosphor. However, such a combination may cause the produced white light to have a slightly different color depending on how far away from the light emitting diode the white light is. In the case of using a yellow phosphor in the blue light source, there is a problem in that the white light becomes yellowish at places far away from the light emitting diode, and as a result, the color sensitivity of a display screen may be changed.

### SUMMARY

Exemplary embodiments of the present invention provide a backlight unit and a display device including the same for providing light supplied from a light source to a display panel without color deviation.

An exemplary embodiment of the present invention provides a backlight unit including a light source. A light guide plate receives light supplied from the light source from an incident light part. A reflective sheet is positioned below the light guide plate. The reflective sheet reflects the light upwardly. A diffuser sheet is formed on the light guide plate. The diffuser sheet diffuses the light to transfer the diffused light upwardly. The diffuser sheet includes a color material, and the color material is provided at different concentrations at a portion corresponding to the incident light part and a portion corresponding to an opposing light part facing the incident light part.

The light source may include a blue LED chip and a yellow phosphor positioned over the entire surface of the blue LED chip.

The concentration of the color material may be decreased toward the opposing light part from the incident light part.

The color material may absorb blue light.

The color material may be a yellow color material.

The concentration of the color material may be increased toward the opposing light part from the incident light part.

The color material may absorb yellow light.

The color material may be a blue color material.

The light guide plate may have one chamfered side, and the light source may input the light to the one chamfered side.

The concentration of the color material of the diffuser sheet may be changed in a vertical direction to a direction of the one chamfered side.

The light sources may be positioned on opposite sides of the light guide plate, and the concentration of the color material may be decreased toward the center, as measured from the opposite sides.

The color material may absorb blue light.

The color material may be a yellow color material.

The light sources may be positioned on opposite sides of the light guide plate, and the concentration of the color material may be increased toward the center, as measured from the opposite sides.

The color material may absorb yellow light.

The color material may be a blue color material.

An exemplary embodiment of the present invention provides a display device, including a backlight unit. A display panel receives light supplied from the backlight to display an image. The backlight unit includes a light source, a light guide plate receiving light supplied from the light source from an incident light part, a reflective sheet positioned below the light guide plate and reflecting the light upward, and a diffuser sheet formed on the light guide plate and diffusing the light to transfer the diffused light upward. The diffuser sheet includes a color material, and the color material has different concentrations at a portion corresponding to the incident light part and a portion corresponding to an opposing light part facing the incident light part.

The light source may include a blue LED chip and a yellow phosphor positioned over the entire surface of the blue LED chip.

The concentration of the color material may be gradually changed toward the opposing light part from the incident light part.

According to exemplary embodiments of the present invention, light supplied to a display panel may be provided without a color deviation by using a diffuser sheet compensating for the color deviation even though a light emitting diode is used. As a result, a color sensitivity of an image provided in the display device is not changed according to a position to thereby preserve display quality.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is an exploded perspective view illustrating a backlight unit according to an exemplary embodiment of the present invention;

FIG. 2 is a plan view illustrating a diffuser sheet according to an exemplary embodiment of the present invention;

FIG. 3 is a graph illustrating a characteristic for a wavelength of the diffuser sheet of FIG. 2 according to an exemplary embodiment of the present invention;

FIG. 4 is a cross-sectional view illustrating a display device according to an exemplary embodiment of the present invention;

FIG. 5 is a plan view illustrating a diffuser sheet according to an exemplary embodiment of the present invention;

FIG. 6 is a graph illustrating a characteristic for a wavelength of the diffuser sheet of FIG. 5 according to an exemplary embodiment of the present invention;

FIG. 7 is a table measuring a color deviation according to a position;

FIG. 8 is a graph simulating a Wy color deviation according to a light guide plate distance;

FIG. 9 is a plan view illustrating a diffuser sheet according to an exemplary embodiment of the present invention;

FIG. 10 is a plan view illustrating a diffuser sheet according to an exemplary embodiment of the present invention;

FIG. 11 is a plan view illustrating a diffuser sheet according to an exemplary embodiment of the present invention;

FIG. 12 is a plan view illustrating a diffuser sheet according to an exemplary embodiment of the present invention; and

FIG. 13 is a diagram sequentially illustrating a manufacturing method of a diffuser sheet according to an exemplary embodiment of the present invention.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., may be exaggerated for clarity. Like reference numerals may designate like elements throughout the specification. It will be understood that when an element such as a layer, film, region, or substrate is referred to as being “on” another element, it can be directly on the other element or intervening elements may also be present.

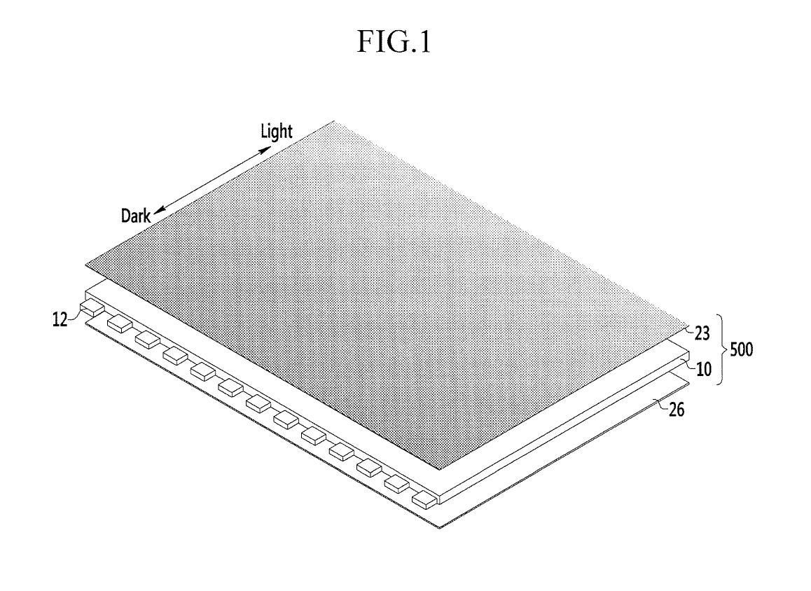

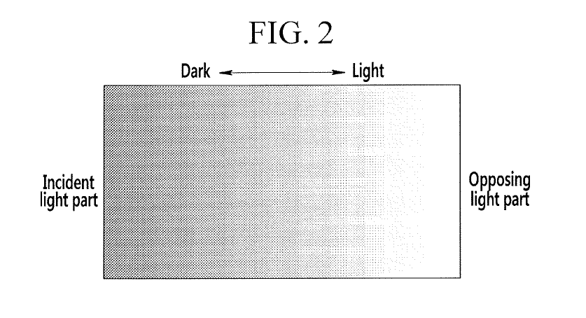

Hereinafter, a backlight unit according to an exemplary embodiment of the present invention will be described in detail with reference to FIGS. 1 and 2.

FIG. 1 is an exploded perspective view illustrating a backlight unit according to an exemplary embodiment of the present invention, and FIG. 2 is a plan view illustrating a diffuser sheet according to an exemplary embodiment of the present invention.

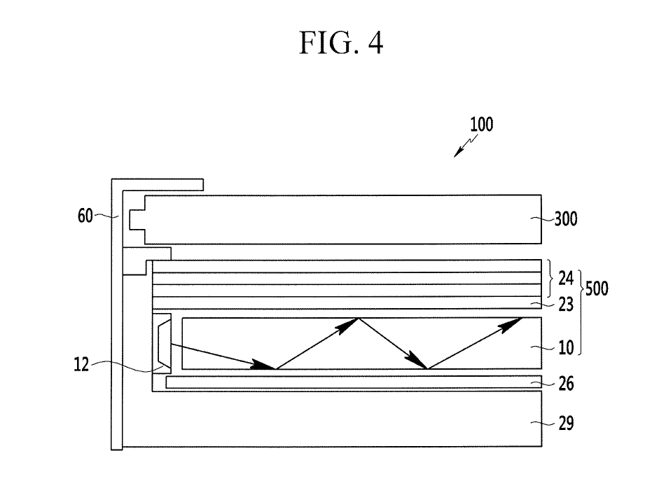

A backlight unit 500 illustrated in FIG. 1 provides light to a liquid crystal panel 300 (see FIG. 4), and the liquid crystal display panel positioned on the backlight unit 500 controls the light supplied by the backlight unit 500 to express gray values, thereby displaying an image.

In order to fasten and fix the backlight unit 500 and the liquid crystal panel as one display device, a top chassis, a mold frame, and a bottom chassis may be provided.

The backlight unit 500 may be formed in various structures, and in FIGS. 1 and 2, one exemplary embodiment thereof is illustrated.

The backlight unit 500 of FIG. 1 includes a light source 12, a light guide plate 10, a reflective sheet 26, and a diffuser sheet 23. Various additional optical sheets may be positioned above the diffuser sheet 23.

A light emitting diode is illustrated as the light source 12. The light emitting diode according to an exemplary embodiment of the present invention includes a blue LED chip and a yellow phosphor (for example, YAG and the like) positioned over the entire surface of the blue LED chip. When blue light is emitted from the blue LED chip, the emitted blue light is partially absorbed by the yellow phosphor which then emits a yellow light. The emitted yellow light mixes with blue light, which may undergo a wavelength transformation, and the resulting light appears white. As a result, the light source 12 emits white light. However, as such a white light supplied from the light source 12 proceeds far away from the light source, a blue light component of the blue light is insufficient, and as a result, a yellowish phenomenon may occur. In the case where a size of the display device is small, it is difficult to recognize the yellowish phenomenon, but in a large-sized display device, the image may be yellowish at a place far away from the light source. When the light source 12 is positioned on one side of the large-sized display device, the yellowish problem may be more noticeable.

As illustrated in FIG. 1, in an exemplary embodiment of the present invention, the light source 12 is arranged in a line on one side of the backlight unit 500. For example, the light source 12 is arranged to supply white light to one side of the light guide plate 10 of the backlight unit 500. Hereinafter, a side where the light source 12 is arranged is called an incident light part and an opposite side is called an opposing light part.

The light guide plate 10 is made of a transparent material transferring the light supplied from the light source 12. The light guide plate 10 may include a pattern of a protrusion or a groove, and the light supplied from the light source 12 through the incident light part is reflected or refracted on the corresponding pattern to be transferred to an upper side of the light guide plate 10. As part of the light may be transferred to a lower side of the light guide plate 10, a reflective sheet 26 is positioned below the light guide plate 10 to reflect light back to the upper side of the light guide plate 10. For example, the reflective sheet 26 may be positioned on the entire lower surface of the light guide plate 10, and may include a material reflecting light.

The light passing through the light guide plate 10 and the reflective sheet 26 may not be entirely uniformly distributed Accordingly, in order to have a more uniform distribution, the diffuser sheet 23 is positioned on the light guide plate 10.

The diffuser sheet 23 scatters the light supplied from the light guide plate 10 to diffuse the scattered light to have a uniform distribution. In addition, the diffuser sheet 23 according to an exemplary embodiment of the present invention includes color materials distributed therein. The color material is distributed within the diffuser sheet at a varying concentration that is dependent upon the position within the diffuser sheet. The concentration of the color material is selected in order to compensate for a color deviation of the light supplied from the light source 12 as illustrated in FIGS. 1 and 2. As the level of yellowing of light may vary depending upon the distance from the light source 12, the concentration of the color material may be selected to compensate for the yellowing accordingly. The color material may include an organic dye or pigment, and a phosphor. The color material may be included in the diffuser sheet 23 itself or may be coated on a surface of the diffuser sheet 23. Alternatively, the color material may be included in a distinct layer placed over the diffuser sheet 23.

As shown in FIGS. 1 and 2, a high concentration of yellow color material may be positioned at the incident light part side in order to compensate for a yellowish phenomenon of the opposing light part due to the light source 12, and the concentration of the yellow color material may be gradually decreased as the color material is far away from the incident light part. At the opposing light part, little to no yellow color material may be included. In such a structure of the diffuser sheet 23 of FIGS. 1 and 2, the concentration of the yellow color material is gradually decreased toward the opposing light part from the incident light part.

In FIG. 1, a separate optical sheet is not illustrated on the diffuser sheet 23, but optical sheets of various combinations may be further included. The optical sheet to be included may be a prism sheet having a prism structure on the sheet surface, or a luminance enhancing film such as a DBEF repetitively forming two different layers. According to an exemplary embodiment, two prism sheets may be used, and in this case, in the two prism sheets, directions in which the prism structure is arranged may be different from each other and may be, for example, perpendicular to each other.

The diffuser sheet 23 illustrated in FIGS. 1 and 2 includes a gradation to illustrate the concentration of the color material. However, the gradation included in FIGS. 1 and 2 may be exaggerated for clarity. The diffuser sheet 23 has a high light-diffusing characteristic and a high light-transmitting characteristic. Further, the color material is added to the diffuser sheet 23 so as to have a concentration difference.

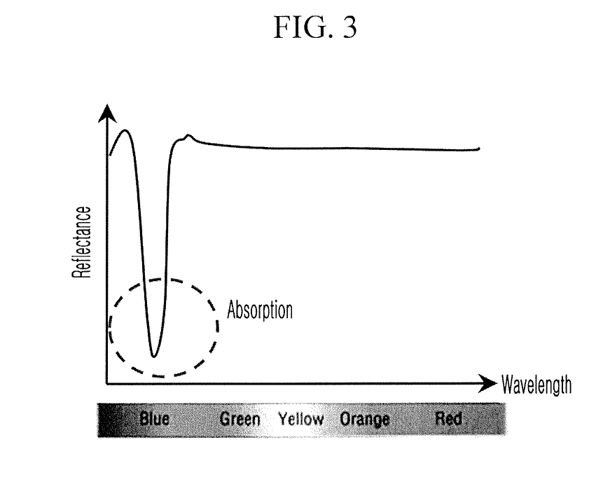

An optical characteristic of a varying concentration of color material in accordance with exemplary embodiments of the present invention is illustrated in FIG. 3. It should be understood that language such as “varying,” and the like, are used in the context of the concentration of color material is intended to express that the concentration changes with respect to location, and not with respect to time. Thus while the disposed concentration remains constant over time, the concentration differs according to location.

FIG. 3 is a graph illustrating a characteristic for a wavelength of the diffuser sheet of FIG. 2 according to an exemplary embodiment of the present invention.

As illustrated in FIG. 3, a yellow color material included in the diffuser sheet 23 absorbs blue light. As a result, the yellow color material may be called a blue absorbing material.

As illustrated in FIG. 3, a yellowish phenomenon occurring in the opposing light part of the backlight unit 500 is reduced by using the color material absorbing blue.

For example, a blue component in the incident light part is reduced by the color material to remove a color deviation in the opposing light part and the incident light part.

Hereinafter, a display device in which the backlight unit 500 is used according to an exemplary embodiment of the present invention will be described with reference to FIG. 4.

FIG. 4 is a cross-sectional view illustrating a display device according to an exemplary embodiment of the present invention.

A display device 100 according to an exemplary embodiment of the present invention includes a backlight unit 500 for supplying light and a liquid crystal panel 300 receiving the light to display an image. In addition, the display device 100 includes a top chassis 60 and a bottom chassis 29 for fixing the backlight unit 500 and the liquid crystal panel 300. The bottom chassis 29 is positioned on the bottom of the backlight unit 500, and the bottom chassis 29 and the backlight unit 500 are integrally referred to as a backlight assembly. According to an exemplary embodiment, the display device 100 further includes a mold frame, and the mold frame is coupled with the bottom chassis 29 to be included in the backlight assembly.

The backlight unit 500 supplies light to the liquid crystal panel 300, and the liquid crystal panel 300 positioned on the backlight unit 500 controls the light supplied from the backlight unit 500 to express gray values, thereby displaying an image.

An integrated circuit chip (IC chip) and a flexible printed circuit board (FPC) may be attached to the liquid crystal panel 300.

The liquid crystal panel 300 includes a TFT substrate including a plurality of thin film transistors (TFTs), an upper substrate positioned on the TFT substrate, and a liquid crystal layer injected between the TFT and upper substrates. The IC chip is mounted on the TFT substrate to control the liquid crystal panel 300.

According to an exemplary embodiment, light receiving type display panels of various exemplary embodiments in addition to the liquid crystal panel 300 may be used on the front side of the backlight unit 500.

The backlight unit 500 for supplying uniform light to the liquid crystal panel 300 is included below the liquid crystal panel 300 to be stored on the bottom chassis 29.

The backlight unit 500 includes a light source 12, a light guide plate 10, a reflective sheet 26, a diffuser sheet 23, and an optical sheet 24. Here, the diffuser sheet 23 diffuses light emitted upward through the light guide plate 10 to uniformly distribute the diffused light, and removes a deviation between the incident light part and the opposing light part to supply light of a uniform color to the liquid crystal panel 300.

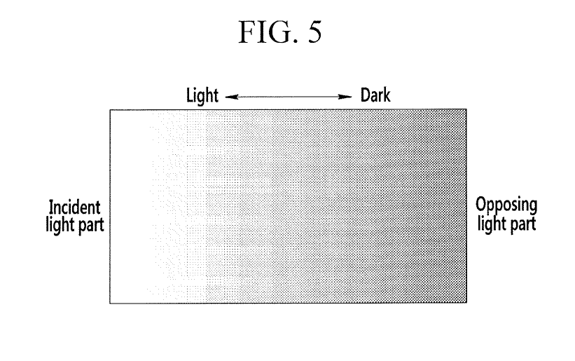

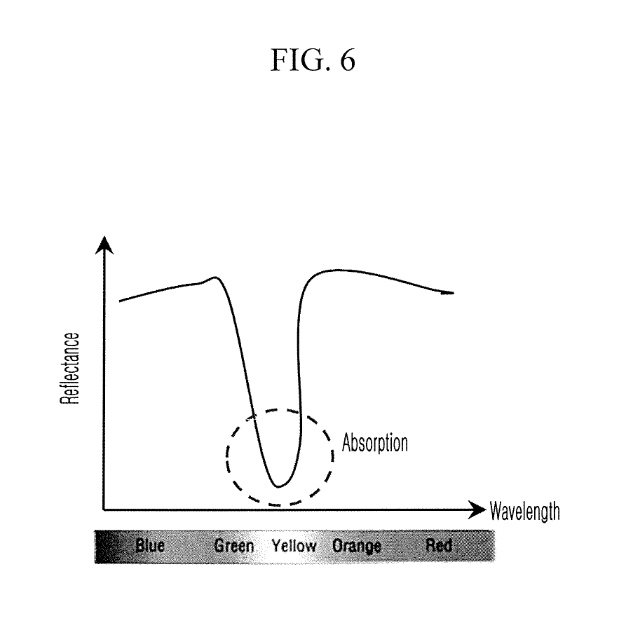

Hereinafter, a diffuser sheet according to an exemplary embodiment and a characteristic thereof will be described with reference to FIGS. 5 and 6.

FIG. 5 is a plan view illustrating a diffuser sheet according to an exemplary embodiment of the present invention, and FIG. 6 is a graph illustrating a characteristic for a wavelength of light through the diffuser sheet of FIG. 5 shown in FIG. 5.

The diffuser sheet 23 according to an exemplary embodiment of the present invention uses a color material having a different characteristic from what is shown in FIGS. 1 and 2. For example, the color material used in the approach shown in FIG. 5 is a blue color material and has a characteristic of absorbing a yellow wavelength light as illustrated in FIG. 6.

Hereinafter, an exemplary embodiment of the present invention will be described in detail with respect to FIG. 5.

The diffuser sheet 23 according to an exemplary embodiment of the present invention scatters the light supplied from the light guide plate 10 to diffuse the scattered light to have a uniform distribution. In addition, in order to compensate for a color deviation of light supplied from the light source 12, the diffuser sheet 23 includes color materials having different concentrations that depends upon its position within the diffuser sheet 23. The color material includes an organic dye or pigment, and may include a phosphor.

The color material included in the diffuser sheet 23 according to an exemplary embodiment of the present invention is disposed at the opposing light part side with a high concentration of the blue color material in order to compensate for a yellowish phenomenon of the opposing light part due to the light source 12, and the concentration of the blue color material may be gradually decreased toward the incident light part from the opposing light part. At the incident light part, substantially no blue color material

may be included. In such a structure of the diffuser sheet 23, the concentration of the blue color material is gradually decreased toward the incident light part from the opposing light part.

The diffuser sheet 23 illustrated in FIG. 5 includes a gradation to illustrate the concentration of the color material. However, the gradation included in FIG. 5 is exaggerated for clarity, and the diffuser sheet 23 has high light diffusing characteristic and light transmitting characteristic, and further, the color material is disposed having a concentration difference.

Like the approach discussed above with respect to FIG. 5, in the case where the blue color material which has a varying concentration is formed in the diffuser sheet 23, an optical characteristic such as is illustrated in FIG. 6 may be provided.

As illustrated in FIG. 6, the blue color material included in the diffuser sheet 23 absorbs yellow light. As a result, the blue color material may be called a yellow absorbing material.

Like FIG. 6, when a yellowish phenomenon occurs in the opposing light part of the backlight unit 500 by using a color material absorbing yellow, the yellowish phenomenon is removed by reducing yellow light and reducing a color deviation between the opposing light part and the incident light part.

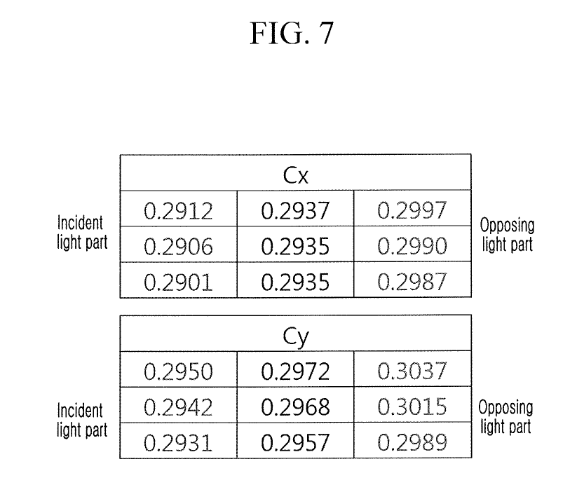

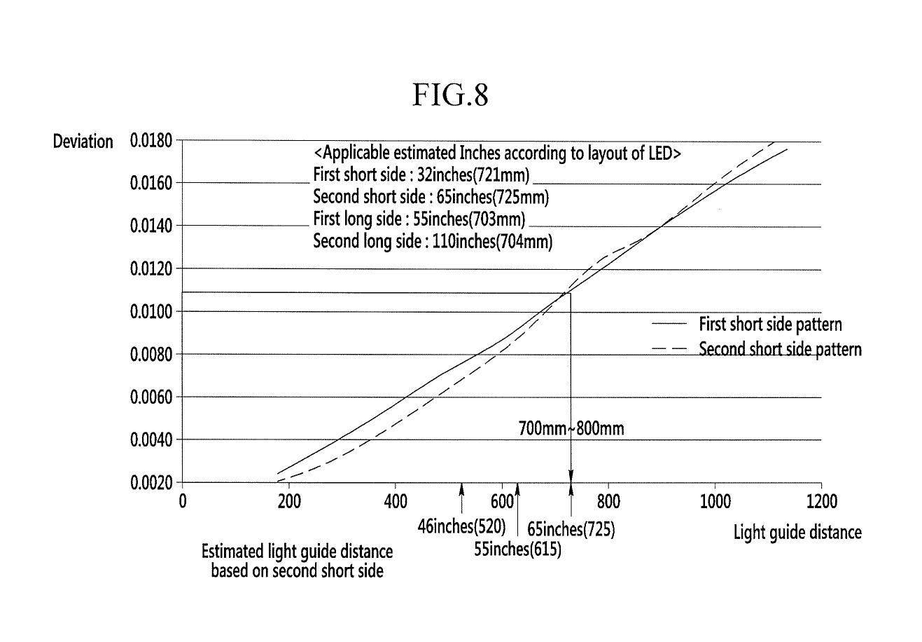

Hereinafter, a color deviation degree according to a method of removing the yellowish phenomenon and a size of the display device will be described with reference to FIGS. 7 and 8.

First, a color deviation degree according to the yellowish phenomenon will be described with reference to FIG. 7.

FIG. 7 is a table measuring a color deviation according to position in accordance with a comparative example.

FIG. 7 is a table in which a degree of a color deviation occurring according to a position at the front side of the backlight unit 500 is measured according to Cx and Cy coordinate values.

In the table of FIG. 7, a left column represents values measured at the incident light part, a right column represents values measured at the opposing light part, and a central column represents values measured at the center. Further, in the table of FIG. 7, a first row represents values measured at an upper side of the backlight unit 500, and a third row represents values measured at a lower side, and a second row represents values measured in the middle thereof.

As a result, the table of FIG. 7 may directly verify differences between Cx or Cy color coordinate values according to a position of the backlight unit 500.

The values of Cx and Cy have differences according to a position as illustrated in FIG. 7, and particularly, it is verified that the values of the incident light part are substantially smaller than the values of the opposing light part. As a result, the yellowish phenomenon is recognized in the opposing light part.

In order to remove the color deviation in which such a yellowish phenomenon occurs, color coordinates of other portions coincide with each other based on a color coordinate of light at the front center of the backlight unit 500 to remove the color deviation.

For example, in the table of FIG. 7, a color material is used at another portion so that values positioned at the center, for example, 0.2935 as a Cx value and 0.2968 as a Cy value coincide with each other. In the approach shown in FIG. 1, the yellow color material is used, and in the approach shown in FIG. 5, the blue color material is used.

As such, when the color deviation is removed, an image supplied by the display device does not have a different color sensitivity according to a position, thereby increasing display quality.

Particularly, when dealing with large display panels in which a distance from the light source can get very big, color deviation may be more pronounced. This phenomenon is illustrated in FIG. 8.

FIG. 8 is a graph simulating a Wy color deviation according to a light guide plate distance.

In FIG. 8, an x axis represents a distance (light guide plate distance) at which the light supplied from the light source 12 proceeds (in units of millimeters), and a y axis represents a deviation of a Wy color coordinate. In FIG. 8, a “first short side” represents a case where the light source 12 is positioned only at one side among short sides of the light guide plate 10, a “second short side” represents a case where the light source 12 is positioned at each of two short sides of the light guide plate 10, a “first long side” represents a case where the light source 12 is positioned only at one side among long sides of the light guide plate 10, and a “second long side” represents a case where the light source 12 is positioned at each of two long sides of the light guide plate 10.

In FIG. 8, as the light guide plate distance is increased, a deviation of the color coordinate is increased, and as a result, the yellowish phenomenon may become a noticeable problem.

Further, according to a simulation of FIG. 8, since the distance at which the light proceeds in the light source 12 is determined according to a position and the number of light sources 12 in the backlight unit 500, the light guide plate 10, and a size of the display device, the position and the number of light sources 12 may be determined by considering a range in which the yellowish phenomenon is not recognized as a problem according to the size of the display device (measured in inches).

For example, according to a simulation of FIG. 8, a structure of the first short side may be applied for display devices having a diagonal size of up to 32 inches, a structure of the second short side may be applied for display devices having a diagonal size of up to 65 inches, a structure of the first long side may be applied for display devices having a diagonal size of up to 55 inches, and a structure of the second long side may be applied for display devices having a diagonal size of up to 110 inches.

Where the color material is included in the diffuser sheet 23 to remove the color deviation, the diffuser sheet 23 may be manufactured such that the yellowish phenomenon is not recognized even in display devices having a diagonal size larger than the sizes illustrated in FIG. 8. In addition, increased display quality may be provided due to a smaller color deviation even in display devices of the same sizes shown in FIG. 8.

As the display device is larger, a region to be covered by the light source 12 is increased, and as a result, a large color deviation occurs and the color material compensates for light having deficient colors in the corresponding region, thereby reducing the color deviation.

In the case of a display device having a large size, due to the color deviation problem, the light source 12 is disposed and used as the second long side structure, but in the light source 12 of the second long side structure, the number of used light emitting diodes is large and it is difficult to drive the light emitting diodes. As a result, in the large-screen display device, a need to use a structure disposed as at least a second short side is magnified. Like the exemplary embodiment of the present invention described above, when the color deviation problem such as a yellowish problem is reduced by using the diffuser sheet 23, even in the large-screen display device, the light source 12 of the second short side structure may be sufficient and additional light sources need not be used.

Further, the diffuser sheet 23 according to an exemplary embodiment of the present invention includes a color material (for example, a dye, a pigment, and the like) selectively coated on an additional portion of the diffuser sheet 23, rather than or in addition to using a separate sheet in which the color material is coated on the entire surface thereof, and as a result, a color change in other regions other than the portion in which it is needed may be minimized.

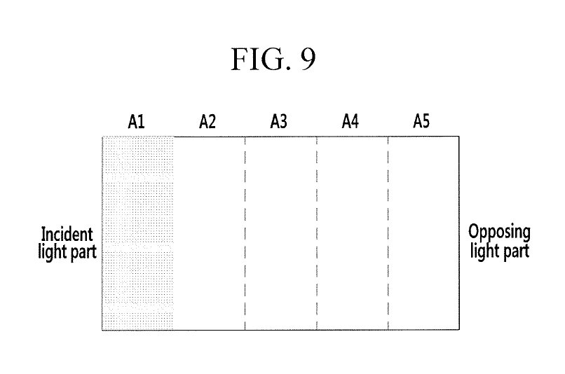

Hereinafter, a diffuser sheet 23 according to an exemplary embodiment of the present invention will be described with reference to FIGS. 9 to 12.

FIGS. 9 to 12 are plan views illustrating a diffuser sheet according to an exemplary embodiment of the present invention.

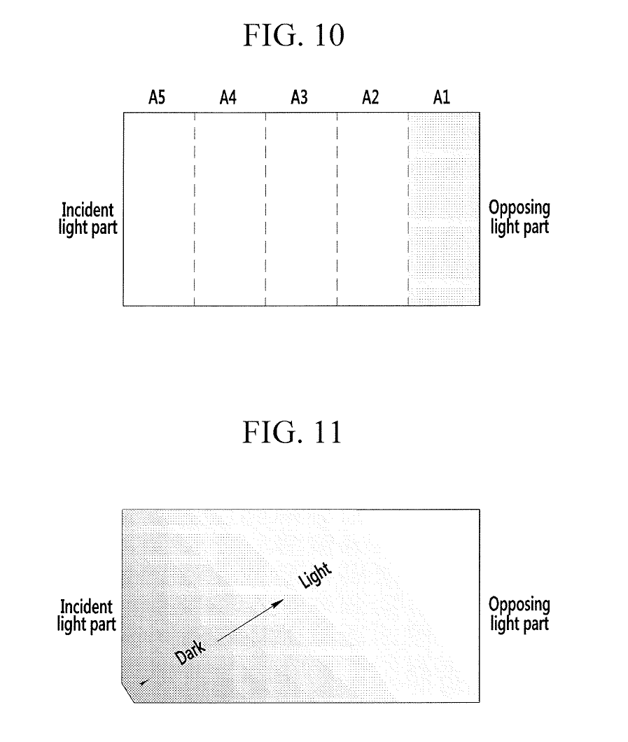

The diffuser sheet 23 of FIGS. 9 and 10 is divided into a plurality of regions between the incident light part and the opposing light part unlike the diffuser sheet 23 of FIGS. 2 and 5. Therefore, the diffuser sheet of FIGS. 9 and 10 has a concentration of different color materials for each region, and has a concentration of the same color material in one region. The diffuser sheet 24 of FIGS. 9 and 10 has a structure in which the concentration of the color material is not gradually changed but is changed abruptly from section to section.

FIG. 9 illustrates an exemplary embodiment in which a yellow color material is used in the manner described above with respect to FIG. 2.

The diffuser sheet 23 of FIG. 9 is divided into five regions between the incident light part and the opposing light part, and includes a yellow color material at a higher concentration toward a region close to the incident light part. Within each region, the concentration of the yellow color material is evenly distributed.

In the diffuser sheet 23 of FIG. 9, a concentration of the yellow color material in a region A1 is largest, a concentration of the yellow color material in a region A2 is second largest, a concentration of the yellow color material in a region A3 is third largest, a concentration of the yellow color material in a region A4 is fourth largest, and a concentration of the yellow color material in a region A5 is smallest. For example, there might be no concentration of yellow color material within the region A5.

In the approach shown in FIG. 9, the color deviation largely occurs on a boundary of each region in which the concentration of the yellow color material is changed, but a deviation is not large enough to be appreciated by the user, and as a result, the color deviation may appear substantially uniform at a predetermined level on the entire display screen and thus the user does not recognize the yellowish phenomenon of the display image.

FIG. 10 illustrates an exemplary embodiment in which a blue color material is used in a manner similar to as is shown in FIG. 5.

The diffuser sheet 23 of FIG. 10 is divided into five regions between the incident light part and the opposing light part, and includes a blue color material having a higher concentration toward a region far away from the incident light part.

In the diffuser sheet 23 of FIG. 10, a concentration of the blue color material in a region A1 is largest, a concentration of the blue color material in a region A2 is second largest, a concentration of the blue color material in a region A3 is third largest, a concentration of the blue color material in a region A4 is fourth largest, and a concentration of the blue color material in a region A5 is smallest. For example, there may be no concentration of the blue color material in the region A5.

As shown in FIG. 10, the color deviation largely occurs on a boundary of each region in which the concentration of the blue color material is changed, but a deviation is not large enough to be recognized by the user, and as a result, the color deviation is uniform at a predetermined level on the entire display screen and thus the user does not recognize the yellowish phenomenon of the display image.

Meanwhile, the diffuser sheet 23 of FIG. 11 may be used when the light source 12 is positioned at an edge of the light guide plate 10.

Since the yellowish phenomenon occurs more noticeably as the diffuser sheet 23 is farther way from the light source 12, in the case where the light source 12 is positioned at the edge, the edge is the incident light part, and a side far away from the edge is the opposing light part. In the diffuser sheet 23 of FIG. 11, the light source 12 is positioned outside of a side obliquely chamfered with respect to a vertical or horizontal side, and light is incident in a vertical direction to the chamfered side. The concentration of the color material is gradually changed according to the vertical direction to the chamfered side. In accordance with the approach shown in FIG. 11, since the yellow color material is used, the concentration of the yellow color material is higher as the light source 12 is closer to the chamfered side, the concentration of the yellow color material is lower as the light source 12 is farther away from the chamfered side, and the yellow color may be substantially omitted from at a portion having the smallest concentration of the yellow color material. In accordance with the approach shown in FIG. 11, in the case of using the blue color material instead of the yellow color material, the concentration of the blue color material is lower as the light source 12 is closer to the chamfered side, and the concentration of the blue color material is higher as the light source 12 is farther away from the chamfered side. The yellow color may be substantially omitted from a portion having the smallest concentration of the blue color material.

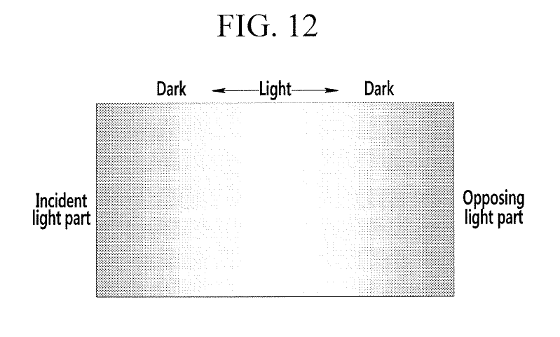

As described above, a diffuser sheet 23 in which the light source 12 is positioned at only one side of the light guide plate 10 is described. Hereinafter, a case where the light sources 12 are positioned at two opposite sides of the light guide plate 10 will be described. In the exemplary embodiment of FIG. 12, the diffuser sheet 23, which is usable when the light sources 12 are positioned at two short sides of the light guide plate 10, is illustrated. The approach of FIG. 12 corresponds to the “second short side” structure in FIG. 8.

In the structure of FIG. 12, the incident light parts are positioned at both opposite sides, and the opposing light part is positioned at the center. As a result, in the incident light parts, which include both opposing sides, the concentration of the yellow color material is high, at the center, the concentration of the yellow color material is small, and the yellow color may be substantially omitted at the center. Meanwhile, in the case of using the blue color material instead of the yellow color material, the concentration of the blue color material is largest in the center, and the concentration of the blue color material is reduced toward the both sides. The yellow color may be substantially omitted from a portion having the smallest concentration of the blue color material.

The structure of FIG. 12 illustrates an exemplary embodiment in which the light sources 12 are positioned at two opposing short sides. The concentration of the color material is changed with respect to a vertical direction.

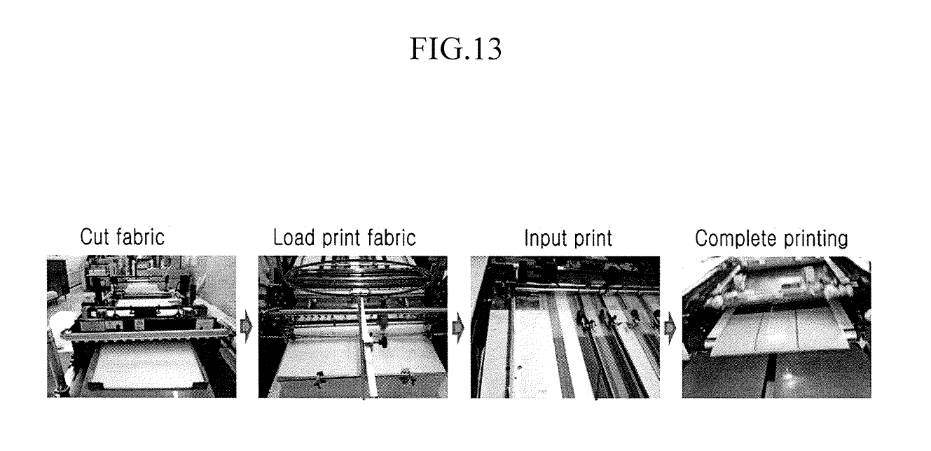

Hereinafter, a method of manufacturing the diffuser sheet 23 according to an exemplary embodiment of the present invention will be described with reference to FIG. 13.

FIG. 13 is a diagram sequentially illustrating a manufacturing method of a diffuser sheet according to an exemplary embodiment of the present invention.

The method of manufacturing the diffuser sheet 23 according to an exemplary embodiment of the present invention includes cutting (creasing) a film (hereinafter, referred to as a diffuser base film) diffusing and transmitting light provided by a backlight unit 500.

Thereafter, the diffuser sheet 23 may be manufactured by a method of coating a color material on one side of the diffuser base film by turning on a printer after putting a machine performing printing (or coating) on the cut diffuser base film. Here, a pattern printed on the surface of the diffuser base film may have various patterns as described above. Further, the color material (e.g., a dye, a pigment, and the like) is printed by using a silk screen printing, metal screen printing, or inkjet printing method as a coating method. In the case of the silk screen printing, the concentration of the color material may vary gradually or abruptly by section by controlling a size of a mesh through which the color material is applied.

According to an exemplary embodiment, when the diffuser base film is manufactured, the color material is included to form the diffuser sheet, and the diffuser sheet may be formed by a method of attaching a film with a separate color material onto the diffuser base film.

While this invention has been described in connection with what is presently considered to be practical exemplary embodiments, it is to be understood that the invention is not limited to the disclosed embodiments, but, on the contrary, is intended to cover various modifications and equivalent arrangements.

What is claimed is:

1. A backlight unit, comprising:
a light source;
a light guide plate receiving light supplied from the light source at an incident light part thereof;
a reflective sheet positioned below the light guide plate and reflecting upwardly light supplied from the light source that emerges from a bottom side of the light guide plate; and
a diffuser sheet formed on the light guide plate and diffusing the light supplied from the light source to transfer the diffused light upwardly,
wherein the diffuser sheet comprises a color material, and a concentration of the color material within the diffuser sheet is dependent upon distance from the incident light part.

2. The backlight unit of claim 1, wherein:
the light source comprises a blue LED chip and a yellow phosphor positioned over an entire surface of the blue LED chip.

3. The backlight unit of claim 2, wherein:
the concentration of the color material is greater toward the incident light part.

4. The backlight unit of claim 3, wherein:
the color material absorbs blue light.

5. The backlight unit of claim 3, wherein:
the color material is a yellow color material.

6. The backlight unit of claim 2, wherein:
the concentration of the color material is lesser toward the incident light part.

7. The backlight unit of claim 6, wherein:
the color material absorbs yellow light.

8. The backlight unit of claim 6, wherein:
the color material is a blue color material.

9. The backlight unit of claim 2, wherein:
the light guide plate has one chamfered side, and
the light source provides the light at the one chamfered side of the light guide plate.

10. The backlight unit of claim 9, wherein:
the concentration of the color material of the diffuser sheet is varied in a direction perpendicular to the direction of the chamfered side.

11. The backlight unit of claim 2, wherein:
the light source includes multiple light source elements that are positioned on two opposite sides of the light guide plate, and
the concentration of the color material is lesser toward the center of the light guide plate and greater toward the two opposite sides of the light guide plate.

12. The backlight unit of claim 11, wherein:
the color material absorbs blue light.

13. The backlight unit of claim 12, wherein:
the color material is a yellow color material.

14. The backlight unit of claim 2, wherein:
the light source includes multiple light source elements that are positioned on two opposite sides of the light guide plate, and
the concentration of the color material is greater toward the center of the light guide plate and lesser toward the two opposite sides of the light guide plate.

15. The backlight unit of claim 14, wherein:
the color material absorbs yellow light.

16. The backlight unit of claim 15, wherein:
the color material is a blue color material.

17. A display device, comprising:
a backlight unit; and
a display panel receiving light supplied from the backlight to display an image,
wherein the backlight unit comprises:
a light source;
a light guide plate receiving light supplied from the light source at an incident light part thereof;
a reflective sheet positioned below the light guide plate and reflecting upwardly light supplied from the light source that emerges from a bottom side of the light guide plate; and
a diffuser sheet formed on the light guide plate and diffusing the light supplied from the light source to transfer the diffused light upwardly,
wherein the diffuser sheet comprises a color material, and a concentration of the color material within the diffuser sheet is dependent upon distance from the incident light part.

18. The display device of claim 17, wherein:
the light source comprises a blue LED chip and a yellow phosphor positioned over an entire surface of the blue LED chip.

19. The display device of claim 18, wherein:
the concentration of the color material is gradually changed along a direction from the incident light part to a part of the diffuser sheet opposite to the indecent light part.

20. A backlight unit, comprising:
a light source;
a light guide plate configured to receive light supplied from the light source at an incident light part thereof; and
a diffuser sheet disposed on the light guide plate, the diffuser sheet configured to diffuse the light supplied from the light source,
wherein the diffuser sheet comprises a color material for changing a color of the light supplied from the light source, and a concentration of the color material within the diffuser sheet is dependent upon distance from the incident light part.
